(19) United States
(12) Patent Application Publication
(10) Pub. No.: US 2023/0375181 A1
(43) Pub. Date: Nov. 23, 2023

(54) V-click N cook

(71) Applicant: Vennela Chimakurty, San Jose, CA (US)

(72) Inventor: Vennela Chimakurty, San Jose, CA (US)

(21) Appl. No.: 18/350,757

(22) Filed: Jul. 12, 2023

(51) Int. Cl. F24C 3/12; G05G 1/08

(52) U.S. Cl. CPC F24C 3/126; G05G 1/08; H01H 19/14

(57) ABSTRACT

This rechargeable battery-powered invention is attached discreetly to any gas stove/range. It controls the stove by powering it on and off with one's phone and auto shuts off in any danger (fire hazards or when no cooking utensils are on the stove). The materials used to create this invention include the camera, thermometer meter, carbon monoxide detector, on and off switch, WiFi enable switch, manual override button, rechargeable battery charge level indicator, enabled timer, magnet, nob holder for circular motion, USB port for battery recharge, memory stick slot (for local storage), outer box, and a display screen. The unit has a circuit, wires, sensors, and batteries. It also includes additional unit installation: two rods to hold multiple units.

### PRIOR ART

1. Omekitchen. Omekitchen, www.omekitchen.com.
2. Amazon. “Smarturns Intelligent Electrical Knob.” Amazon, www.amazon.com/Smarturns-Intelligent-eletrical-2-knobs-Vertical/dp/B08J4FP DP P.
3. Tochtech. “Smarturns Vertical.” Tochtech, www.tochtech.com/store-smarturns-vertical/.
4. Engadget. “Inirv React: Smart Stove Knob.” Engadget, 5 Jan. 2017, www.engadget.com/2017-01-05-inirv-react-smart-stove-knob.html.
5. YouTube. “Smart Knobs for Your Stove—Inirv React.” YouTube, uploaded by OddityMall, 15 Dec. 2016, www.youtube.com/watch?v=HxfM7i3O48g&ab_channel=OddityMall.

### BACKGROUND OF THE INVENTION

A new work-life integration emerged with COVID and more people working from home. Of the many changes that need to be adapted, using the home kitchen while working is one. Attending to the stove or waiting during work hours is often difficult. This device helps manage the stove remotely and keep an eye on it with a camera and app that allows you to control the device at all times with a simple WiFi connection.

### SUMMARY OF THE INVENTION

This rechargeable battery-powered invention is attached discreetly to any gas stove/range. It controls the stove by powering it on and off with one's phone and auto shuts off in any danger (ex. fire hazards or when no cooking utensils are on the stove). This battery-powered invention allows users to control their stoves remotely, and with the built-in camera, they can monitor stove activity without being present in the kitchen.

### BRIEF DESCRIPTION OF DRAWINGS

FIG. 1: Front and Side View

FIG. 2: Back View

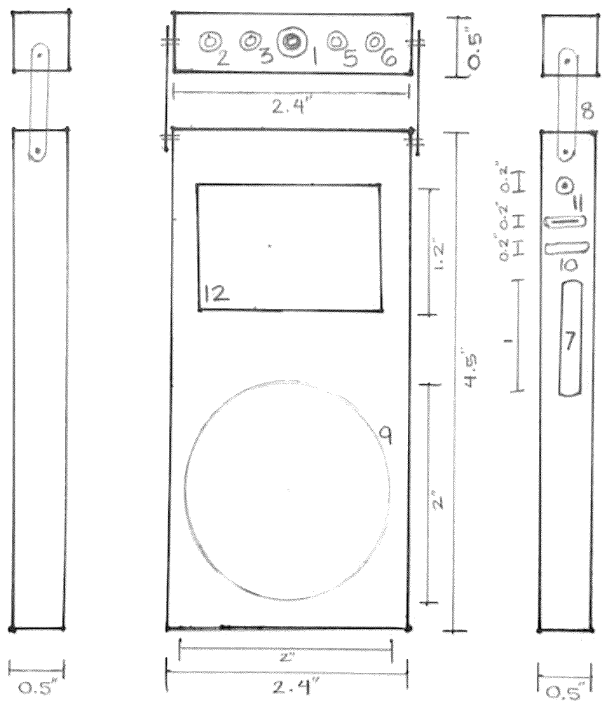

In FIG. 1, a front and side view of the invention is shown, displaying the external structure and arrangement of components. The front side comprises a camera (1), thermometer measurer (2), carbon monoxide sensor (3), WiFi enable switch (5), manual override button (6), nob holder for circular motion (9), and the display screen (12). The side shows the on and off control switch (4), rechargeable battery charge level indicator (7), holder hooks (8), USB port for battery recharge (10), and the memory stick slot for local storage (11). All components are interconnected via appropriate wiring and circuits, which are not specifically drawn for clarity.

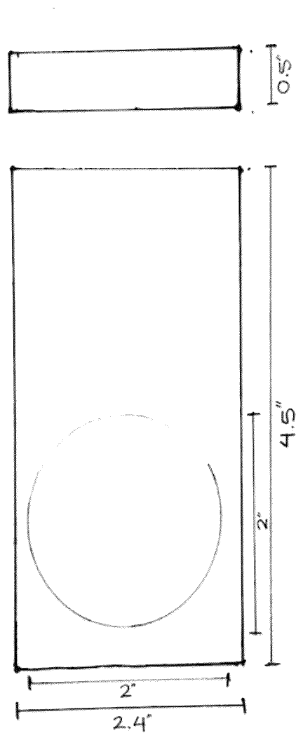

FIG. 2 provides a back view of the invention. The rear view is rather simple, with a magnet (15) placed on the surface, allowing the unit to attach to any magnetic platform, not just the stove knob panel itself. This allows for easy storage and access.

### DETAILED DESCRIPTION OF THE INVENTION

This rechargeable battery-powered invention works as a single unit. The unit can be accessed with your mobile phone and manually overridden. Just place the unit on the turning knob of the stove, and fix the unit with the help of the back magnet. This rechargeable battery-powered invention is like Amazon's fire stick, making any stove range into a smart WiFi enabled stove. This unit fits most stove ranges and can be carried anywhere and used effortlessly. To make the invention, the parts listed first must be assembled by installing the circuit board, memory stick slot, USB slot, battery, and display screen. Next, the camera on the lever should be fixed. Then, the lid should be closed then tightened with the screws. Finally, the battery should be charged with the USB slot. To use this invention, one must simply attach the Click n Cook unit. The camera is attached to the main unit with a liver on both sides of the unit to move up & down. The thermometer and carbon monoxide sensor are attached to the main unit, while the on and off switch, manual override button, and WiFi enable switch are on the main unit's side. There is a battery power indicator as well on the display screen. The Nob holder is in the middle of the unit. The USB port for recharging the battery and the memory stick slot are found at the bottom of the unit. An indication light of battery low shows when it is time for a recharge. It can be carried to any stove range, attached to the knob, and this can activate the desired function. The steps to use it are as follows:
1. Ensure you are connected to data or WiFi (this is only for the initial pairing with the V—click N cook app).
2. Enable Bluetooth on your mobile device.
   If you're on an iOS device, check that your Location Permissions are enabled.
   If you're on a device using Android 12+, check that your nearby permissions are also enabled.
   Make sure that you are in Bluetooth range for connection.
3. In the V—click N cook app, tap Home and the + plus sign in the top left.
4. Tap Add Device>Home>V—click N cook.
5. Tap Skip Installation Guide if you've already installed your V—click N cook Lock Bolt on your door. If not, tap Begin Installation.
6. Press and hold the pairing button under the batteries (the round dent with “P” on it). You should hear three beeps once you release the pairing button, and the unit should flash white.
7. Wait for the V—click N cook app to search for and connect to your V—click N cook unit.
8. Name your V—click N cook unit. Then you're all set!

You can now control the stove on/off. You can turn the knob to SIM, MEDIUM, or HIGH, and how long you want to keep it on. You can also enable Video to see how it is working. For multiple units, follow the same steps from 1 to 5 and name them differently. The unit checks the CO levels (carbon monoxide) before it functions. Before switching it on, the unit's camera checks for any utensils on the stove and checks if there is any fire hazard around.

1. A rechargeable battery-powered unit for converting a conventional stove range into a smart Wi-Fi-enabled stove, comprising:
a. a housing unit designed to be placed on the turning knob of the stove range,
b. a circuit board integrated within the unit,
c. a memory stick slot and a USB slot integrated within the housing unit for data storage and battery charging purposes,
d. a battery positioned within the housing unit to power the unit,
e. a display screen within the unit for visual feedback and control,
f. a camera fixed on a lever attached to the housing unit, enabling up and down movement,
g. a thermometer and a carbon monoxide sensor attached to the housing unit,
h. an on/off switch, a manual override button, and a Wi-Fi-enabled switch located on the side of the housing unit,
i. a battery power indicator displayed on the housing unit's display screen,
j. A magnetic strip on the back side of the housing unit,
k. a knob holder positioned in the middle of the housing unit,
l. an indicator light on the display screen that indicates low battery power and the need for recharging,
m. a mobile phone interface for remote access and control of the unit's functionalities,

2. The rechargeable battery-powered unit of any preceding claim, wherein the camera, thermometer, and carbon monoxide sensor provide real-time monitoring and feedback on cooking processes and safety conditions.
